(19) United States
(12) Patent Application Publication
(10) Pub. No.: US 2007/0114865 A1
(43) Pub. Date: May 24, 2007

(54) Oilless bearing type motor with function of preventing oil leakage

(75) Inventor: Sung Gon Son, Seoul (KR)

Correspondence Address: BACON & THOMAS, PLLC, 625 SLATERS LANE, FOURTH FLOOR, ALEXANDRIA, VA, 22314, US

(73) Assignee: DAEWOOD ELECTRONICS CORPORATION, Seoul (KR)

(21) Appl. No.: 11/603,003

(22) Filed: Nov. 22, 2006

(30) Foreign Application Priority Data
Nov. 23, 2005 (KR) 10-2005-0112291

(51) Int. Cl. H02K 5/16

(52) U.S. Cl. 310/90; 310/261

(57) ABSTRACT

An oilless bearing type motor with a function of preventing oil leakage, wherein the motor includes an oilless bearing supporting a rotational shaft to be rotatable, includes a rotor of which the rotational shaft is fixed in a central portion. The rotor has an oil collecting indentation around the rotational shaft to collect oil leaked from an oilless bearing side, and is formed by pressing soft magnetic powder. Further, The oilless bearing type motor includes an oil absorption ring formed of a material absorbing a liquid to allow the oil, which moves by a centrifugal force in the oil collection indentation, to be absorbed, and installed in the oil collecting indentation.

### FIELD OF THE INVENTION

The present invention relates to an oilless bearing type motor with a function of preventing oil leakage, and more particularly, to an oilless bearing type motor with a function of preventing oil leakage so as to improve durability and reliability of the motor.

### BACKGROUND OF THE INVENTION

In general, a motor is a device that converts electrical energy into mechanical energy to provide a rotational force. Motors are being widely applied to various industrial fields including electric home appliances and industrial machines. For instance, motors can be applied to compressors, which are installed inside cooling appliances such as air conditioners and refrigerators to restore a refrigerant to a liquid, washing machines, vacuum cleaners, optical disk players, and hard disk drivers of computers.

Such a motor, particularly, a small-sized motor is installed with a self-lubricant oilless bearing to smoothly rotate a rotational shaft. A conventional oilless bearing type motor will be described with reference to FIG. 1 hereinafter.

FIG. 1 illustrates a sectional view of main parts of a conventional oilless bearing type motor 10. The oilless bearing type motor 10 includes a holder 11, a casing (not shown), a stator (not shown), a rotor 12, and a rotational shaft 13. The holder 11 is attached to the casing (not shown) on both upper and lower sides. Although not illustrated, the stator is affixed to the inside of the casing. The rotor 12 is inserted into the stator (not shown) to be rotatable by having a gap inside the stator (not shown). The rotational shaft 13 passes through a central region of the rotor 12 and is affixed thereto. The rotational shaft 13 is inserted into the holder 11 to be rotatable by means of the oilless bearing 14.

The holder 11 includes a bearing installation unit 11a in a central region of the holder 11, and the oilless bearing 14 is installed on the bearing installation unit 11a.

The oilless bearing 14 is formed of a sintered metal with multiple pores, and does not include oil but do include lubricating oil inside the pores of the sintered metal material, so that the oilless bearing 14 can be self-lubricant. One portion of the oilless bearing 14 exposed by the bearing installed unit 11a is elastically supported by a plate spring 15 so as to prevent separation of the oilless bearing 14 from the bearing installation unit 11a.

The plate spring 15 is attached to an exterior portion of the bearing installation unit 11a of the holder 11, and a bearing cover 16 that shields an inflow of foreign materials firmly fixes the plate spring 15.

Around the oilless bearing 14, the holder 11 provides a space that a permawick 17 having oil can fill.

The permawick 17 supplies the oil to those portions where friction occurs, for instance, a contact region between the oilless bearing 14 and the rotational shaft 13.

In the conventional motor 10, the rotational shaft 13 supported to be rotatable by the oilless bearing 14 rotates with the rotor 12 due to magnetic flux generated between the stator (not shown) and the rotor 12 by the power supplied to the motor 10. At this time, the oil provided from the oilless bearing 14 and the permawick 17 is supplied to those parts where friction is induced, so that the rotational shaft 13 can rotate smoothly.

However, as the rotational shaft 13 rotates, the rotational shaft 13 and the oilless bearing 14 are likely to produce frictional heat. Thus, the temperature around the permawick 17 and the oilless bearing 14 tends to increase. This temperature increase causes the oil that the oilless bearing 14 and the permawick 17 contain is mixed into a gel-type fibroid material to thereby decrease the viscosity of the oil. As a result, the oil is likely to leak along the rotational shaft 13 and scatter due to a rotational force of the rotor 12. Accordingly, those injection molding materials composing the interior parts of the motor 10 often deteriorate, and the deteriorated parts are easily broken, resulting in degradation of durability and reliability of the motor 10.

### SUMMARY OF THE INVENTION

It is, therefore, an object of the present invention to provide an oilless bearing type motor with a function of preventing oil leakage so as to prevent deterioration and breakage of injection molding materials composing parts of the motor and thus to improve durability and reliability of the motor.

In accordance with a preferred embodiment of the present invention, there is provided an oilless bearing type motor with a function of preventing oil leakage, wherein the motor includes an oilless bearing supporting a rotational shaft to be rotatable, the oilless bearing type motor including a rotor to which the rotational shaft is affixed in a central region, including an oil collecting indentation around the rotational shaft to collect oil leaked from an oilless bearing side, and formed by pressing soft magnetic powder, and an oil absorption ring including a material capable of absorbing a liquid to allow the oil moving by a centrifugal force at the oil collection indentation and installed in the oil collecting indentation.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a sectional view of main parts of a conventional oilless bearing type motor;

FIGS. 2A and 2B illustrate a sectional view of main parts of an oilless bearing type motor with an oil leakage prevention function in accordance with an embodiment of the present invention; and

FIG. 3 is a perspective view illustrating how an absorption ring of the oilless bearing type motor is attached to a target in accordance with an embodiment of the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art.

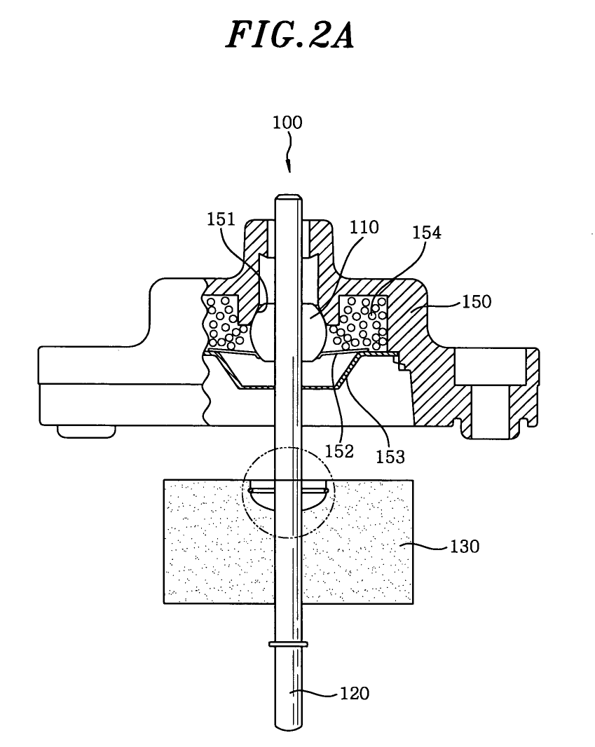

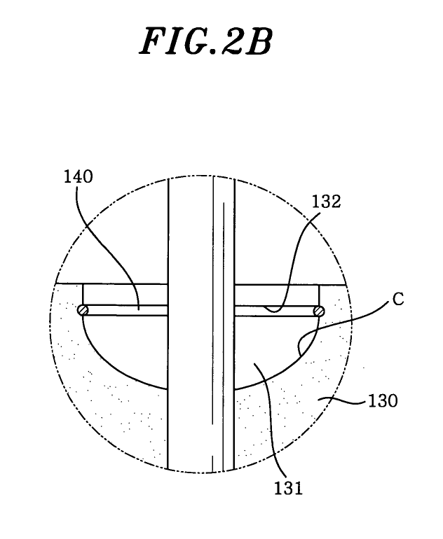

FIGS. 2A and 2B illustrate a sectional view of an oilless bearing type motor with a function of preventing oil leakage in accordance with an embodiment of the present invention. The oilless bearing type motor 100 with the oil leakage prevention function includes an oilless bearing 110, a rotational shaft 120, a rotor 130, an oil collecting indentation 131, and an oil absorption ring 140. The rotational shaft 120 is supported to be rotatable by the oilless bearing 110. The rotor 130 is affixed to a central region of the rotational shaft 120 and formed by pressing soft magnetic powder so as to form the oil collecting indentation 131. The oil absorption ring 140 is installed in the oil collecting indentation 131 of the rotor 130.

Although not illustrated, the oilless bearing 110 is installed on a holder 150 attached to a casing on both upper and lower sides. The oilless bearing 110 supplies lubricating oil contained in pores of a sintered material to an attached region to the rotational shaft 120 so as to support the rotational shaft 120 to be rotatable.

A bearing installation unit 151 is disposed in an interior central region of the holder 150 to install the oilless bearing 110 thereon. A plate spring 152 is placed on one portion of the oilless bearing 110 exposed by the bearing installation unit 151, and thus, the plate spring 152 can elastically support the oilless bearing 110. A bearing cover 153 is attached to an exterior portion of the bearing installation unit 151, and firmly fixes the plate spring 152.

A permawick 154 having oil fills the holder 150 around the oilless bearing 110 to supply the oil to those regions where friction occurs, e.g., a contact region between the rotational shaft 120 and the oilless bearing 110.

The rotational shaft 120 is affixed to a central region of the rotor 130 so as to rotate with the rotor 130.

The rotor 130 is placed inside a stator (not shown), which is affixed to the inner surface of the casing (not shown), by having a gap inside the stator (not shown), and rotates due to an electron induction event generated by the stator (not shown). The rotor 130 includes the oil collecting indentation 131 formed around a certain region of the rotational shaft 120 to collect the oil leaked from the oil bearing 110.

As mentioned above, the rotor 130 is molded by pressing the soft magnetic powder. The soft magnetic powder includes iron-based particles, each coated with a certain material to be electrically insulated from each other.

In detail of the formation of the oil collection indentation 131, a press molding apparatus includes a molding space formed in a shape substantially the same as the rotor 130, and the soft magnetic powder is filled into the molding space. A pressing member such as a punch presses the soft magnetic powder to form the oil collecting indentation 131 in the rotor 130. A lubricant and/or a binder may be added to the soft magnetic powder and pressed together.

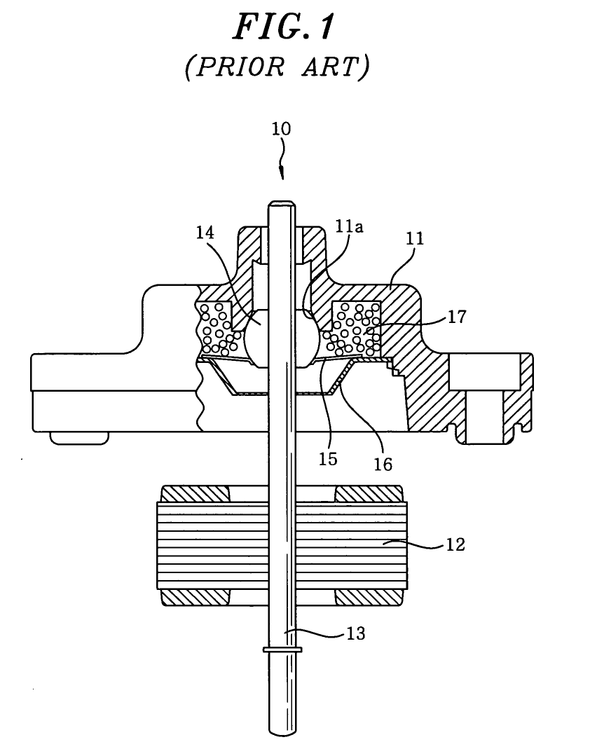

The rotor 130 includes a three-dimensional soft magnetic composite (SMC) by pressing the soft magnetic powder, and usually has a higher degree of freedom as compared with the conventional rotor 12 (see FIG. 1) obtained by stacking silicon steel sheets over each other. As a result of this high degree of structural freedom, different from the conventional stack structure of the rotor 12, the oil collecting indentation 131 can be formed in the rotor 130.

The oil absorption ring 140 includes a felt-based material or a material that can absorbs a liquid, e.g., porous synthetic resin. The oil absorption ring 140 is installed inside the oil collecting indentation 131 such that the rotational shaft 120 is allocated at an interior central region of the oil absorption ring 140. The oil moving due to a centrifugal force is absorbed at the oil collecting indentation 131.

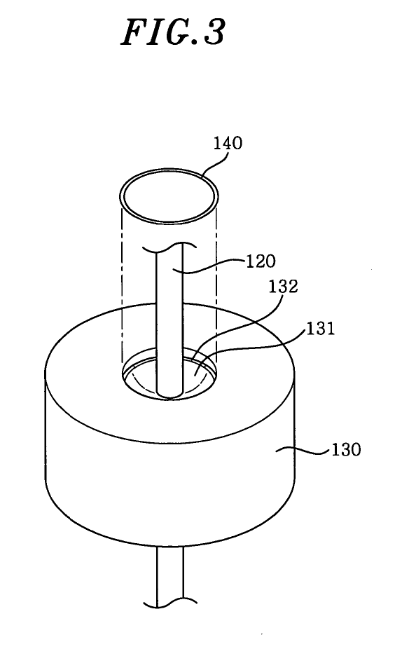

The oil absorption ring 140 can be forcefully inserted into the oil collecting indentation 131. Preferably, as illustrated in FIG. 3, the oil absorption ring 140 can be fit into a ring installation groove 132 formed along the inner surface of the oil collection indentation 131. As a result, the oil absorption ring 140 does not come off.

The oil collecting indentation 131 is preferably formed to be curved from the rotational shaft 120 to the oil absorption ring 140 to guide the oil collected along the rotational shaft 120 to smoothly move to the oil absorption ring 140 and be rapidly absorbed. Reference label ‘C’ in FIG. 2B denotes the curved shape of the oil collecting indentation 131.

Although FIG. 2B illustrates the oil collecting indentation 131 and the oil absorption ring 140 disposed on only one side of the rotor 130, the oil collecting indentation 131 and the oil absorption ring 140 can be formed and installed on both sides of the rotor 130.

The above oilless bearing type motor operates as follows.

In the oilless bearing type motor 100 with oil leakage prevention function, when the temperature of the permawick 154 and the oilless bearing 110 increases due to frictional heat generated between the rotational shaft 120 and the oilless bearing 110 as the rotational shaft 120 rotates, the oil of the permawick 154 and the oilless bearing 110 is often mixed into a gel-type fibroid material, thereby reducing the viscosity of the oil that the permawick 154 and the oilless bearing 110 contain. As a result, the oil is likely to leak along the rotational shaft 120, and collected at the oil collecting indentation 131.

The oil collected at the oil collecting indentation 131 moves to the direction of a centrifugal force generated by the rotation of the rotor 130 and reaches the oil absorption ring 140 to be absorbed. Therefore, the oil leaked from the oilless bearing 110 is not likely to scatter inside the motor 100.

The oil absorption ring 140 is fixed into the ring installation groove 132 of the oil collection indentation 131, and thus, even though the rotor 130 rotates, the oil absorption ring 140 is firmly affixed thereto. Also, due to the curved portion of the oil collection indentation 131 extending from the rotational shaft 120 to the oil absorption ring 140 inside the oil collection indentation 131, the oil leaked from the rotational shaft 120 can smoothly move to the oil absorption ring 140. Thus, the oil absorption ring 140 can effectively absorb the moving oil.

Different from the conventional rotor 12 (see FIG. 1) obtained by stacking the identically shaped silicon steel sheets over each other, the oil collecting indentation 131 of the rotor 130 can be formed by the press molding of the soft magnetic material.

According to various embodiments of the present invention, the oilless bearing type motor can prevent the oil leakage, and thus, further can prevent deterioration and breakage of injection molding materials composing the parts of the motor, usually caused by the oil leakage. As a result, durability and reliability of the motor can be improved.

While the invention has been shown and described with respect to the preferred embodiments, it will be understood by those skilled in the art that various changes and modifications may be made without departing from the spirit and scope of the invention as defined in the following claims.

What is claimed is:

1. An oilless bearing type motor with a function of preventing oil leakage, wherein the motor includes an oilless bearing supporting a rotational shaft to be rotatable, the motor comprising:
a rotor of which the rotational shaft is fixed in a central portion, including an oil collecting indentation around the rotational shaft to collect oil leaked from an oilless bearing side, and formed by pressing soft magnetic powder; and
an oil absorption ring formed of a material absorbing a liquid to allow the oil, which moves by a centrifugal force in the oil collection indentation, to be absorbed, and installed in the oil collecting indentation.

2. The motor of claim 1, wherein a ring installation groove is formed on an inner surface of the oil collecting indentation, the oil absorption ring being fit into the ring installation groove.

3. The motor of claim 1, wherein the oil collecting indentation is formed in a curved surface from the rotation shaft to the oil absorption ring to guide the movement of the oil.
